(19) United States
(12) Patent Application Publication
(10) Pub. No.: US 2021/0174421 A1
(43) Pub. Date: Jun. 10, 2021

(54) DYNAMICALLY DETERMINING CROSS-SELL AND UP-SELL ITEMS FOR COMPANION SHOPPERS

(71) Applicant: INTERNATIONAL BUSINESS MACHINES CORPORATION, Armonk, NY (US)

(72) Inventors: Raghuveer Prasad Nagar, Kota (IN); Anurag Srivastava, Pune (IN); Manjit Singh Sodhi, Bangalore (IN)

(21) Appl. No.: 16/703,983

(22) Filed: Dec. 5, 2019

(51) Int. Cl. G06Q 30/06; G06K 9/00; G06Q 50/00

(52) U.S. Cl. CPC G06Q 30/0631; G06Q 50/01; G06K 9/00335; G06Q 30/0643

(57) ABSTRACT

A computer-implemented method for presenting a companion shopper with one or more additional items to cross-sell and/or up-sell based on selected items of a first user and a predicted checkout time for the first user. The computer-implemented method includes detecting one or more items for purchase associated with the first user, and recognizing a second user paired with the first user. The computer-implemented method further includes determining one or more additional items to present to the second user, based on one or more of the following: the detected one or more items already selected by the first user, one or more item requirements of the second user, and current pricing and available promotions. The computer-implemented method further includes presenting the determined one or more additional items to the second user.

### BACKGROUND

The present disclosure relates generally to the field of cognitive computing, Internet of Things (IoT), and more particularly to data processing and cross-selling and up-selling items to companion shoppers of a primary shopper.

Shoppers in retail stores oftentimes shop with a companion, someone physically accompanying them. For example, a primary shopper and a companion may go together to a shopping mall to shop for a dress. Although both the primary shopper and the shopper's companion need to be together for the shopping, the companion may become disinterested for some, or most of the time, during the shopping activity.

During the shopping activity, the retailer (e.g., salesperson, website) caters only around the interests that the shopper has explicitly, or implicitly, expressed. As such, retailers lose out on potential sales activity with the shopper's companion.

### BRIEF SUMMARY

Embodiments of the present invention disclose a method, a computer program product, and a system.

According to an embodiment, a method, in a data processing system including a processor and a memory, for implementing a program that presents additional items to a user for purchase. The method detects one or more items for purchase associated with a first user. The method recognizes a second user paired with the first user, and determines one or more additional items for purchase to present to the second user. The method further presents the determined one or more additional items for purchase to the second user.

According to another embodiment, a computer program product for directing a computer processor to implement a program that presents additional items to a user for purchase. The storage device embodies program code that is executable by a processor of a computer to perform a method. The method detects one or more items for purchase associated with a first user. The method recognizes a second user paired with the first user, and determines one or more additional items for purchase to present to the second user. The method further presents the determined one or more additional items for purchase to the second user.

According to another embodiment, a system for implementing a program that manages a device, includes one or more computer devices each having one or more processors and one or more tangible storage devices. The one or more storage devices embody a program. The program has a set of program instructions for execution by the one or more processors. The program instructions include instructions for presenting additional items to a user for purchase. The program instructions include instructions for detecting one or more items for purchase associated with a first user. The program instructions further include instructions for recognizing a second user paired with the first user, and determining one or more additional items for purchase to present to the second user. The program instructions further include instructions for presenting the determined one or more additional items for purchase to the second user.

### BRIEF DESCRIPTION OF THE DRAWINGS

FIG. 1 illustrates a dynamic selling computing environment, in accordance with an embodiment of the present invention.

FIG. 2 is a flowchart illustrating the operation of dynamic selling agent program of FIG. 1, in accordance with an embodiment of the present invention.

FIG. 3 is a diagram graphically illustrating the hardware components of a dynamic selling computing environment of FIG. 1, in accordance with an embodiment of the present invention.

FIG. 4 depicts a cloud computing environment, in accordance with an embodiment of the present invention.

FIG. 5 depicts abstraction model layers of the illustrative cloud computing environment of FIG. 4, in accordance with an embodiment of the present invention.

### DETAILED DESCRIPTION

The present invention discloses an artificial intelligence (AI) and internet of things (IoT) based system and method for both physical and virtual stores (e.g., website, mobile application, etc.) to cross-sell and up-sell retail items (e.g., products and services) based on identified items in a shopper's shopping cart, predicted checkout time of the shopper, and the person(s) who are physically accompanying the shopper during the shopping visit (e.g., a shopper's companion).

The present invention also discloses a system and method capable of detecting boredom (i.e., disinterest) of a shopper's companion(s) in the physical store, predicts the checkout time, and based on the estimated time before checkout, engages the bored companions in shopping activities with the shopper.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

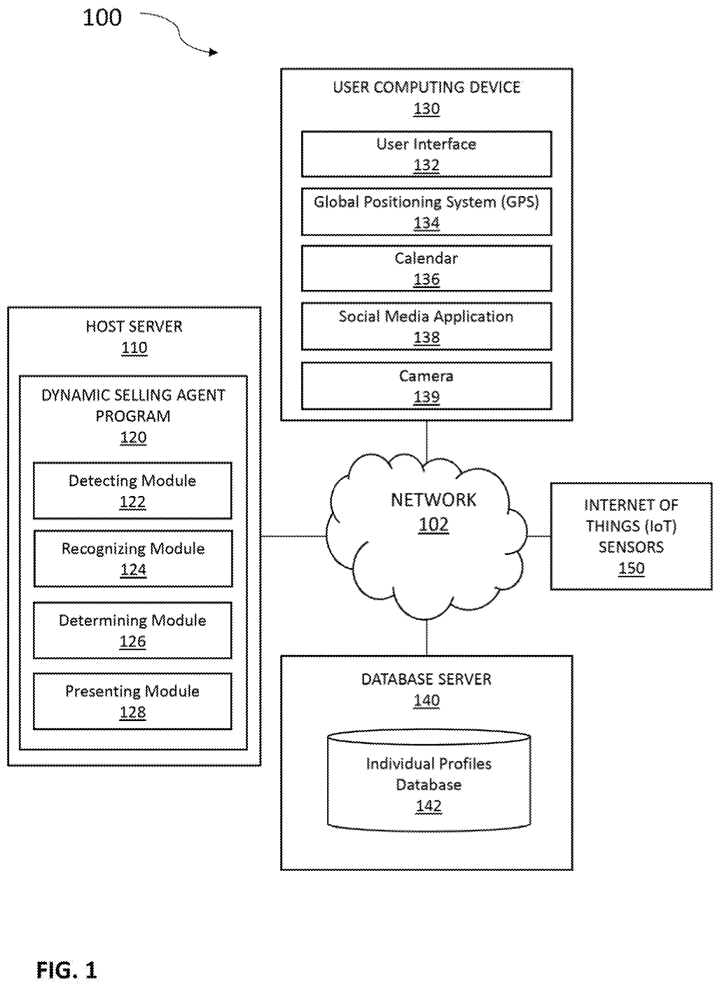

FIG. 1 illustrates dynamic selling computing environment 100, in accordance with an embodiment of the present invention. Dynamic selling computing environment 100 includes host server 110, user computing device 120, database server 140, and Internet of Things (IoT) sensors 150, all connected via network 102. The setup in FIG. 1 represents an example embodiment configuration for the present invention, and is not limited to the depicted setup in order to derive benefit from the present invention.

In exemplary embodiments, network 102 is a communication channel capable of transferring data between connected devices and may be a telecommunications network used to facilitate telephone calls between two or more parties comprising a landline network, a wireless network, a closed network, a satellite network, or any combination thereof. In another embodiment, network 102 may be the Internet, representing a worldwide collection of networks and gateways to support communications between devices connected to the Internet. In this other embodiment, network 102 may include, for example, wired, wireless, or fiber optic connections which may be implemented as an intranet network, a local area network (LAN), a wide area network (WAN), or any combination thereof. In further embodiments, network 102 may be a Bluetooth network, a WiFi network, or a combination thereof. In general, network 102 can be any combination of connections and protocols that will support communications between host server 110, user computing device 130, database server 140, and IoT sensors 150.

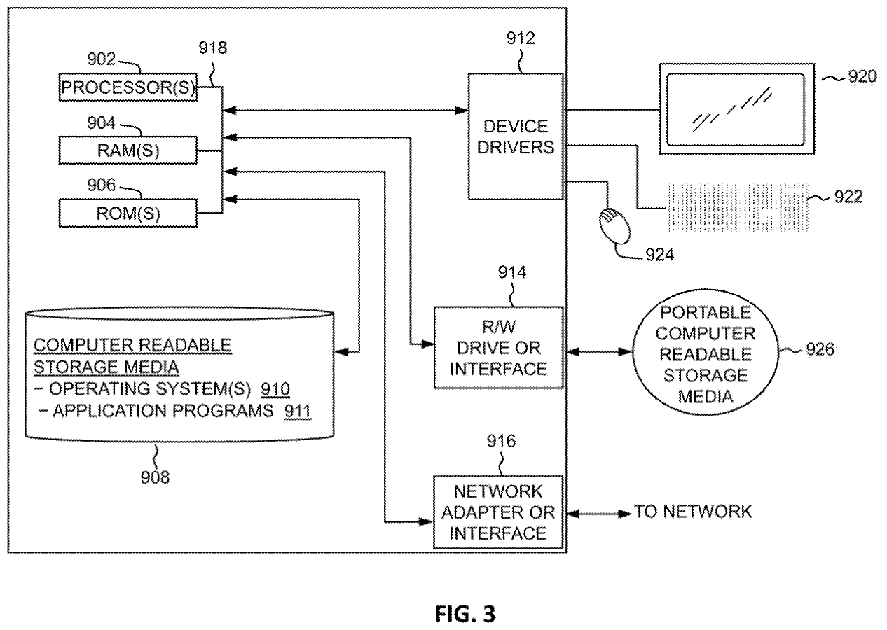

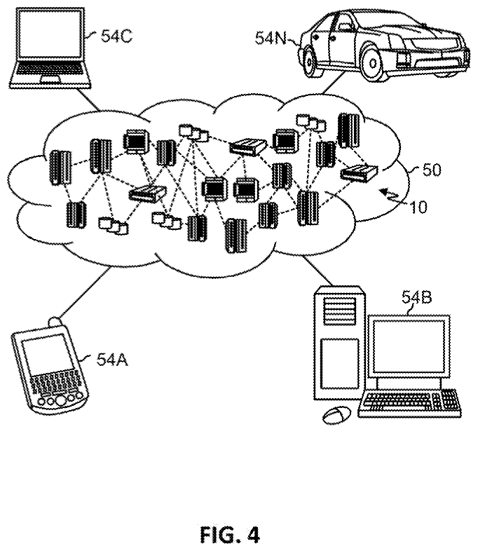

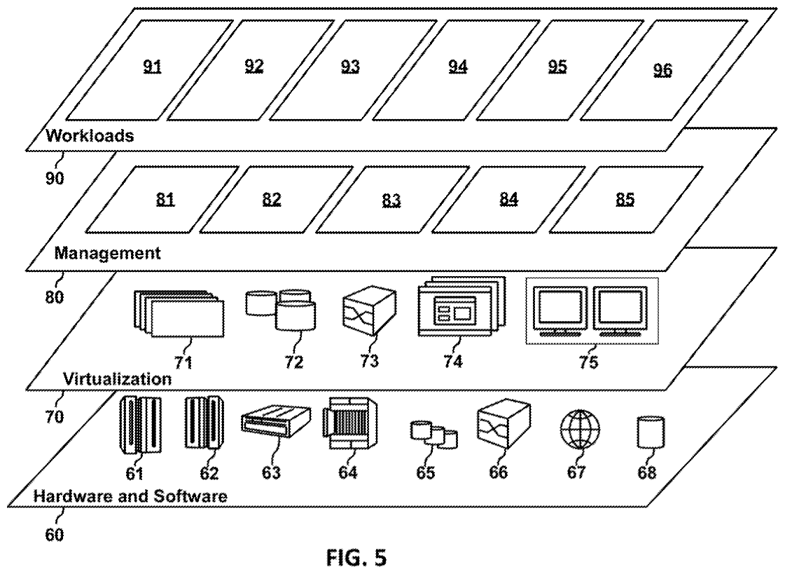

In exemplary embodiments, host server 110 includes dynamic selling agent program 120. In various embodiments, host server 110 may be a laptop computer, tablet computer, netbook computer, personal computer (PC), a desktop computer, a personal digital assistant (PDA), a smart phone, a server, or any programmable electronic device capable of communicating with user computing device 130, database server 140, and IoT sensors 150 via network 102. Host server 110 may include internal and external hardware components, as depicted and described in further detail below with reference to FIG. 3. In other embodiments, host server 110 may be implemented in a cloud computing environment, as described in relation to FIGS. 4 and 5, herein. Host server 110 may also have wireless connectivity capabilities allowing it to communicate with user computing device 130, database server 140, IoT sensors 150, and other computers or servers over network 102.

In exemplary embodiments, user computing device 130 includes user interface 132, global positioning system (GPS) 134, calendar 136, social media application 138, and camera 139. In various embodiments, user computing device 130 may be a laptop computer, tablet computer, netbook computer, personal computer (PC), a desktop computer, a personal digital assistant (PDA), a smart phone, or any programmable electronic device capable of communicating with host server 110, database server 140, and IoT sensors 150 via network 102. User computing device 130 may include internal and external hardware components, as depicted and described in further detail below with reference to FIG. 3. In other embodiments, user computing device 130 may be implemented in a cloud computing environment, as described in relation to FIGS. 4 and 5, herein. User computing device 130 may also have wireless connectivity capabilities allowing it to communicate with host server 110, database server 140, IoT sensors 150, and other computers or servers over network 102.

In an exemplary embodiment, user computing device 130 includes user interface 132, which may be a computer program that allows a user to interact with user computing device 130 and other connected devices via network 102. For example, user interface 132 may be a graphical user interface (GUI). In addition to comprising a computer program, user interface 132 may be connectively coupled to hardware components, such as those depicted in FIG. 3, for receiving user input. In an exemplary embodiment, user interface 132 may be a web browser, however in other embodiments user interface 132 may be a different program capable of receiving user interaction and communicating with other devices.

In an exemplary embodiment, GPS 134 is a computer program on user computing device 130 that provides time and location information for a user. Modern GPS systems operate on the concept of time and location. In modern GPS systems, four or more satellites broadcast a continuous signal detailing satellite identification information, time of transmission (TOT), and the precise location of the satellite at the time of transmission. When a GPS receiver picks up the signal, it determines the difference in time between the time of transmission (TOT) and the time of arrival (TOA). Based on the amount of time it took to receive the signals and the precise locations of the satellites when the signals were sent, GPS receivers are capable of determining the location where the signals were received. In an exemplary embodiment, GPS 134 is capable of providing real-time location detection of the user, proximity to a specific store and/or companion, and so forth.

In exemplary embodiments, calendar 136 may be a computer program, on user computing device 130, that syncs a user's electronic calendar from another computing device, or application, to calendar 136. Calendar 136 may include a user's personal calendar such as birthdays, vacation dates, travelling schedule, personal event information and get togethers, as well as a user's work calendar such as meeting dates/times, conference dates/times, travelling schedule dates/times, and so forth. Calendar 136, in exemplary embodiments, is capable of communicating with dynamic selling agent program 120.

In exemplary embodiments, social media application 138 may be a computer program, on user computing device 130, that is capable of receiving natural language text input of a user, location identifier of a user, streaming/live video of a user, photographs of a user, check-ins at restaurant/bar/stadium establishments, and so forth, from a user, which may be consolidated and analyzed and provide a glimpse into social activity patterns of a user. The more frequently, consistently, and accurately a user interacts with a social media application 138, the more genuine of a measurement of social patterns and interests of a user (e.g., when a user engages in social events, wardrobe of a user based on posted photographs, interests of a user, contacts of a user, etc.) may be obtained.

In exemplary embodiments, camera 139 may include one or more devices capable of recording a user (e.g., body gestures, facial recognition, etc.), in accordance with embodiments of the present disclosure. In exemplary embodiments, cameras 139 installed on user computing device 130 and/or within a store where a user is shopping (or accompanying a shopper) are capable of constructing a feature set in real-time for each user (e.g., facial recognition, user purchase history, user interests, user emotional state, etc.) using video analytics software, such as IBM® Intelligent Video Analytics (all IBM-based trademarks and logos are trademarks or registered trademarks of International Business Machines Corporation and/or its affiliates). In exemplary embodiments, individuals must opt-in, and may opt-out at any time, prior to any tracking or location information of a user is obtained.

In exemplary embodiments, database server 140 includes individual profiles database 142 and may be a laptop computer, tablet computer, netbook computer, personal computer (PC), a desktop computer, a personal digital assistant (PDA), a smart phone, a server, or any programmable electronic device capable of communicating with host server 110, user computing device 130, and IoT sensors 150 via network 102. While database server 140 is shown as a single device, in other embodiments, database server 140 may be comprised of a cluster or plurality of computing devices, working together or working separately.

In exemplary embodiments, individual profiles database 142 may contain a list of one or more users, together with a profile associated with each user. The individual user profile may include shopping history, personal details about the user (e.g., age, gender, clothing size, average shopping time, hobbies, interests, purchase history, and so forth). In exemplary embodiments, individuals must opt-in, and may opt-out at any time, prior to any personal information is obtained, tracked, and/or stored. Individual profiles database 142 may also include a list of potential shopping suggestions based on user's interests, shopping history, and detected events on calendar 136. In this fashion, individual profiles database 142 is a dynamic database capable of automatically being updated based on detected purchases of the user.

In various embodiments, individual profiles database 142 is capable of being stored on dynamic selling agent program 120, or host server 110, as a separate database.

In exemplary embodiments, internet of things (IoT) sensors 150 may be located within the house of a user, within a shopping center, or in any other location capable of collecting data about one or more users via one or more electronic devices of the user, such as user computing device 130. IoT sensors 150 may include embedded computing systems that allow objects, such as user computing device 130, to be sensed or controlled remotely across existing network infrastructure, such as network 102, thus creating opportunities for more direct integration of the physical world into computer-based systems, and resulting in improved efficiency, accuracy, and economic benefit in addition to reduced human intervention.

With continued reference to FIG. 1, dynamic selling agent program 120, in an exemplary embodiment, may be a computer application on computing device 110 that contains instruction sets, executable by a processor. The instruction sets may be described using a set of functional modules. Dynamic selling agent program 120 receives input from user computing device 130, database server 140, and IoT sensors 150 in order to cross-sell and up-sell one or more additional items to recognized second users (i.e., shoppers) accompanying a primary user (i.e., shopper), or the primary user itself.

In alternative embodiments, dynamic selling agent program 120 may be a standalone program on a separate electronic device or server. In an exemplary embodiment, dynamic selling agent program 120 may be configured to store various preferences for a user (e.g., device tracking, shopping history, access to calendar 136 and social media application 138 data, etc.).

With continued reference to FIG. 1, the functional modules of dynamic selling agent program 120 include detecting module 122, recognizing module 124, determining module 126, and presenting module 128.

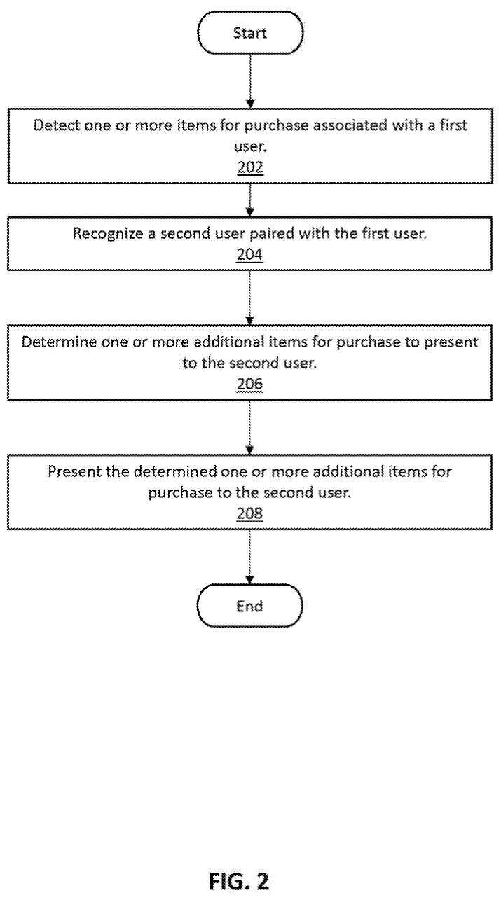

FIG. 2 is a flowchart illustrating the operation of dynamic selling agent program 120 of FIG. 1, in accordance with embodiments of the present invention.

With reference to FIGS. 1 and 2, detecting module 122 includes a set of programming instructions, in dynamic selling agent program 120, to detect one or more items for purchase, associated with a first user (step 202). The set of programming instructions is executable by a processor.

In exemplary embodiments, a user may enter either a virtual store or a physical store to go shopping. In exemplary embodiments, detecting module 122 may be a smart cart (in a physical store) or an e-commerce website platform (for a virtual store). For example, in the case of an e-commerce platform, a user may be identified via login information (e.g., unique username and password). In exemplary embodiments, a smart cart includes scanners capable of scanning the barcode labels of one or more products as they are placed into the smart cart in order to identify the items for purchase. In other embodiments, smart carts may include image-recognition cameras, weight sensors (to automatically identify an item), and any other technology, known to one of ordinary skill in the art, that is capable of identifying items placed within the smart cart.

In exemplary embodiments, a smart cart and an e-commerce website platform are capable of identifying both the user and the selected one or more items to be purchased.

With reference to an illustrative example at a physical store, Susan enters a fully automated shopping center with her husband Larry. Fully automated shopping centers typically do not include any cashiers, but rather utilize smart carts and IoT sensor technology to keep track of user selected items and purchases. Both Susan and Larry are registered shoppers at the automated shopping center, meaning their account and identification are linked to their smart cart. Susan is the primary shopper, as she is the one actively looking for a dress to buy. Susan selects a dress to purchase and scans the barcode label of the dress as she places it in her smart cart. The smart cart detects the selected dress.

With reference to an illustrative example at a virtual store, Susan and Larry visit an e-commerce website. Susan and Larry are both registered users at the e-commerce website. Susan logs into her account by entering a unique username and password. Susan selects a dress to purchase from the website and places it in the e-shopping cart. Detecting module 122 detects the selected dress and associates it with Susan's online account.

With continued reference to FIGS. 1 and 2, recognizing module 124 includes a set of programming instructions in dynamic selling agent program 120, to recognize a second user paired with the first user (step 204). The set of programming instructions is executable by a processor.

In exemplary embodiments, a second user may be recognized whether the first user is in a physical store or a virtual store.

In exemplary embodiments, recognizing module 124 may recognize a second user based on the location detection of a user computing device of the second user. For example, via GPS 134, recognizing module may ascertain the proximity of the first user with a user comping device of the second user. In exemplary embodiments, recognizing module 124 may have access to a first user's contacts from user computing device 130, calendar 136, and/or social media applications 138. The first user and second user may, upon full disclosure and consent, activate device tracking on their respective user computing device 130 (e.g., mobile device) preferences. In this fashion, recognizing module 124 is capable of recognizing the proximity of the first user and second user at a given location. In various embodiments, a second user may include one or more of family members, friends, public figures, and so on.

In alternative embodiments, recognizing module 124 may detect a user log-in on an e-commerce platform and associate a second user with the log-in of a first user, based on a combined account, or via preferences, set up by the first user. For example, a husband and wife may have a shared e-commerce account so that when the wife logs-in to the e-commerce account, the husband is recognized and associated with the online shopping cart too.

In further embodiments, recognizing module 124 may recognize a second user shopping with a first user based on social media updates and/or check-ins on social media application 138.

In further embodiments, recognizing module 124 may recognize a second user in a physical store based on facial recognition technology via cameras 139. In a virtual store (e.g., an e-commerce platform), a second user may further be identified by cameras 139 located on a user computing device 130.

In exemplary embodiments, recognizing module 124 is capable of recognizing one or more emotional states of a second user, such as a state of boredom. In exemplary embodiments, the recognized state of boredom of the second user may be determined, based on user-state data, including but not limited to, at least one of the following: data from a camera 139 (e.g., facial recognition technology to identify facial expressions; gesture monitoring, etc.), data from a vitals monitor (e.g., lower heart rate indicating lack of exertion, etc.), data from a microphone (e.g., voice recognition technology using natural language processing techniques to determine sentiment of a second user, etc.), and data from one or more social media applications 138 (e.g., status updates on social media indicating a state of boredom, etc.).

In exemplary embodiments, cameras 139 (either in a physical store or on user computing device 130 while shopping in a virtual store) are used to capture real-time visual data (e.g., picture, video, etc.). The media captured by the cameras 139 are matched against social media applications 138 (e.g, pictures, check-in, status posts, etc.) and IoT data (e.g, smart home data) of the second user that is accompanying the first user. Image and video processing techniques, known to one of ordinary skill in the art, are used while matching the captured media with the social media applications 138 and IoT data of the second user.

With continued reference to the illustrative examples above (at both the physical store and the virtual store), recognizing module 124 does not recognize Larry since he is not a registered shopper and he is not associated with Susan's shopping account. Cameras within the physical store (or via user computing device 130) capture video of Larry and use facial recognition techniques to match Larry's image with social media applications 138. Recognizing module 124 recognizes Larry as Susan's husband, based on tagged photographs of Larry and Susan together on Susan's social media applications 138.

With continued reference to FIGS. 1 and 2, determining module 126 includes a set of programming instructions in dynamic selling agent program 120, to determine one or more additional items for purchase to present to the second user (step 206). The set of programming instructions is executable by a processor.

In exemplary embodiments, determining module 126 may be capable of determining an occasion for the shopping visit based on a selected item of the first user, the calendar 136 of either the first user or the second user, and social media application 138 of either the first user or the second user.

For example, the calendar 136 entry of the first user may indicate that their wedding anniversary is next week. Additionally, the calendar 136 entry of the second user may also indicate their wedding anniversary on the same day as the first user.

Furthermore, the social media application 138 of both the first and the second users may contain a check-in status update indicating that they are shopping for new clothes for a night out at a fancy restaurant next week.

In exemplary embodiments, determining module 126 determines one or more additional items to present to the second user for purchase based on one or more of, but not limited to, the following factors: the detected one or more items already selected for purchase by the first user; one or more item requirements of the second user; and current pricing and available promotions.

For example, determining module 126 may determine that the second user can also use a pair of running sneakers based on the pair of running sneakers in the shopping cart of the first user. Furthermore, determining module 126 may determine, based on the second user's social media and calendar data, that the second user recently purchased a gym membership and may benefit from a new pair of running sneakers. Additionally, determining module 126 may determine that there is a store promotion for ‘buy one pair of running sneakers, get second pair at half price’.

In further exemplary embodiments, determining module 126 may determine one or more item requirements of the second user by analyzing data from social media application data of the second user, IoT data of the second user, and calendar data of the second user.

In exemplary embodiments, determining module 126 may determine one or more additional items that complement the one or more items of the first user (e.g., matching shoes with a selected dress, etc.) and notify the first user and the second user.

In exemplary embodiments, determining module 126 may generate one or more dynamic promotions for the determined one or more additional items and present, in real time, the generated dynamic promotions to the first user and the second user.

With continued reference to the illustrative examples above (at both the physical store and the virtual store), determining module 124 determines that Susan and Larry are shopping together for fancy clothes for their anniversary dinner next week. Determining module 124 was capable of making this determination by accessing Susan and Larry's calendar 136 and social media application 138 data, in addition to the fact that Susan selected a fancy evening gown and placed it in the smart cart. Additionally, determining module 124 determines a complementary suit for Larry that matches Susan's selected evening gown and generates a dynamic promotion offering 25% discount on both items if purchased together.

With continued reference to FIGS. 1 and 2, presenting module 128 includes a set of programming instructions in dynamic selling agent program 120, to present the determined one or more additional items for purchase to the second user (step 208). The set of programming instructions is executable by a processor.

In exemplary embodiments, presenting module 128 may present the determined one or more additional items for purchase to the second user via text message, email, and/or popup to a user computing device 130 of the second user. In alternative embodiments, presenting module 128 may present the determined one or more additional items for purchase via a message delivered on a display on the smart cart, or online shopping cart of the first user, or in any other fashion common to one of ordinary skill in the art.

In exemplary embodiments, dynamic selling agent program 120 is capable of predicting a checkout time for the first user and presenting the determined one or more additional items for purchase to the second user if the predicted checkout time exceeds a threshold value.

In various embodiments, predicting the checkout time for the first user is based on, but not limited to, one of the following factors: an item type, shopping history of the first user, and a calendar 136 of the first user. For example, if the item type includes apparel (e.g., clothes, shoes, etc.) then these items may require the first user to try them on, thus extending the length of time before checking out and paying for the selected items.

The shopping history of the first user, accessed via individual profiles database 142, is another factor that may influence the checkout time. For example, if the first user recently purchased the same size item (e.g., dress, shoes, etc.) then there may not be a need for the first user to try the item on, thus shortening the length of time before checking out and paying for the selected items.

The calendar 136 data of the first user is also a factor taken into consideration, by dynamic selling agent program 120, when predicting the checkout time for the first user. For example, the first user's calendar 136 may indicate that the first user has a meeting with a friend in the next 20 minutes, thus shortening the length of time before checking out and paying for the selected items.

With continued reference to the illustrative examples above (at both the physical store and the virtual store), dynamic selling agent program 120 recognizes that Susan is shopping with Larry. However, dynamic selling agent program 120 predicts that Susan's checkout time will be in less than 15 minutes, based on Susan's calendar 136 entry indicating that she has a personal lunch meeting with a friend in 10 minutes. Since the predicted checkout time for Susan does not exceed a minimum 15 minute threshold value, dynamic selling agent program 120 does not present any of the determined one or more additional items to Larry.

FIG. 3 is a block diagram depicting components of a computing device (such as host server 110 and user computing device 130, as shown in FIG. 1), in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Computing device of FIG. 3 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as dynamic selling agent program 120, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device of FIG. 3 may also include a R/W drive or interface 914 to read from and write to one or more portable computer readable storage media 926. Application programs 911 on computing device of FIG. 3 may be stored on one or more of the portable computer readable storage media 926, read via the respective R/W drive or interface 914 and loaded into the respective computer readable storage media 908.

Computing device of FIG. 3 may also include a network adapter or interface 916, such as a TCP/IP adapter card or wireless communication adapter (such as a 4G wireless communication adapter using OFDMA technology). Application programs 911 on computing device of FIG. 3 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Computing device of FIG. 3 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and controlling access to data objects 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present invention. Therefore, the present invention has been disclosed by way of example and not limitation.

What is claimed is:

1. A computer-implemented method, comprising:
detecting one or more items for purchase, associated with a first user;
recognizing a second user paired with the first user;
determining one or more additional items for purchase to present to the second user; and
presenting the determined one or more additional items for purchase to the second user.

2. The computer-implemented method of claim 1, further comprising:
predicting a checkout time for the first user; and
presenting the determined one or more additional items for purchase to the second user if the predicted checkout time exceeds a threshold value.

3. The computer-implemented method of claim 1, wherein determining the one or more additional items to present to the second user are based on a factor, the factor being selected from a group consisting of: the detected one or more items already selected by the first user; one or more item requirements of the second user; and current pricing and available promotions.

4. The computer-implemented method of claim 3, wherein the one or more item requirements of the second user are determined by analyzing data, selected from a group consisting of: social media data of the second user, Internet of Things (IoT) data of the second user, and calendar data of the second user.

5. The computer-implemented method of claim 1, further comprising:
recognizing a state of boredom of the second user, wherein the recognized state of boredom of the second user is determined based on user-state data, selected from a group consisting of: camera data, vitals monitor data, microphone data, and data from one or more social media applications.

6. The computer-implemented method of claim 1, further comprising:
generating one or more dynamic promotions for the determined one or more additional items; and
presenting, in real time, the generated dynamic promotions to the first user and the second user.

7. The computer-implemented method of claim 2, wherein predicting the checkout time for the first user is based on one of the following factors, selected from a group consisting of: an item type, shopping history of the first user, and a calendar of the first user.

8. The computer-implemented method of claim 1, further comprising:
notifying the first user and the second user of the one or more additional items that complement the one or more items of the first user.

9. A computer program product, comprising a non-transitory tangible storage device having program code embodied therewith, the program code executable by a processor of a computer to perform a method, the method comprising:
detecting one or more items for purchase, associated with a first user;
recognizing a second user paired with the first user;
determining one or more additional items for purchase to present to the second user; and
presenting the determined one or more additional items for purchase to the second user.

10. The computer program product of claim 9, further comprising:
predicting a checkout time for the first user; and
presenting the determined one or more additional items for purchase to the second user if the predicted checkout time exceeds a threshold value.

11. The computer program product of claim 9, wherein determining the one or more additional items to present to the second user are based on a factor, the factor being selected from a group consisting of: the detected one or more items already selected by the first user; one or more item requirements of the second user; and current pricing and available promotions.

12. The computer program product of claim 11, wherein the one or more item requirements of the second user are determined by analyzing data, selected from a group consisting of: social media data of the second user, Internet of Things (IoT) data of the second user, and calendar data of the second user.

13. The computer program product of claim 9, further comprising:
recognizing a state of boredom of the second user, wherein the recognized state of boredom of the second user is determined based on user-state data, selected from a group consisting of: camera data, vitals monitor data, microphone data, and data from one or more social media applications.

14. The computer program product of claim 9, further comprising:
generating one or more dynamic promotions for the determined one or more additional items; and
presenting, in real time, the generated dynamic promotions to the first user and the second user.

15. The computer program product of claim 10, wherein predicting the checkout time for the first user is based on one of the following factors, selected from a group consisting of: an item type, shopping history of the first user, and a calendar of the first user.

16. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
detecting one or more items for purchase, associated with a first user;
recognizing a second user paired with the first user;
determining one or more additional items for purchase to present to the second user; and
presenting the determined one or more additional items for purchase to the second user.

17. The computer system of claim 16, further comprising:
predicting a checkout time for the first user; and
presenting the determined one or more additional items for purchase to the second user if the predicted checkout time exceeds a threshold value.

18. The computer system of claim 16, wherein determining the one or more additional items to present to the second user are based on a factor, the factor being selected from a group consisting of: the detected one or more items already selected by the first user; one or more item requirements of the second user; and current pricing and available promotions.

19. The computer system of claim 18, wherein the one or more item requirements of the second user are determined by analyzing data, selected from a group consisting of: social media data of the second user, Internet of Things (IoT) data of the second user, and calendar data of the second user.

20. The computer system of claim 16, further comprising:
recognizing a state of boredom of the second user, wherein the recognized state of boredom of the second user is determined based on user-state data, selected from a group consisting of: camera data, vitals monitor data, microphone data, and data from one or more social media applications.
